(19) United States
(12) Patent Application Publication
(10) Pub. No.: US 2026/0070674 A1
(43) Pub. Date: Mar. 12, 2026

(54) ADJUSTING A TRAJECTORY OF AN EXTRATERRESTRIAL VEHICLE BASED ON AN OPERATIONAL CYCLE

(71) Applicant: Blue Origin Manufacturing, LLC, Huntsville, AL (US)

(72) Inventors: Christopher John Sullivan, JR., Seattle, WA (US); Daniel John Grebow, Pasadena, CA (US); David Gardiner, Los Angeles, CA (US); Martin Thomas Ozimek, Marriottsville, MD (US)

(21) Appl. No.: 19/328,065

(22) Filed: Sep. 12, 2025

Related U.S. Application Data
(60) Provisional application No. 63/694,103, filed on Sep. 12, 2024.

(51) Int. Cl. B64G 1/24

(52) U.S. Cl. CPC B64G 1/242

(57) ABSTRACT

A trajectory determination system configured to: obtain a reference trajectory for an extraterrestrial vehicle; obtain a truth trajectory for the extraterrestrial vehicle that identifies estimated movement of the extraterrestrial vehicle from an initial state towards a user-specified target; separate a duration of the reference trajectory into a plurality of operational cycles, wherein each of the plurality of operational cycles represent time durations in which the extraterrestrial vehicle flies a particular trajectory before updating an onboard thrust profile based on an estimate of a state of the extraterrestrial vehicle; obtain a thrust profile for an operational cycle of the plurality of operational cycles; apply the thrust profile to the truth trajectory for the operational cycle, wherein applying the thrust profile reduces at least some movement of the extraterrestrial vehicle due to the error.

### CROSS-REFERENCE TO RELATED APPLICATIONS

This application claims priority under 35 U.S.C. § 119 (e) to U.S. Provisional Application No. 63/694,103, entitled “ADJUSTING A TRAJECTORY OF AN EXTRATERRESTRIAL VEHICLE USING A STATISTICAL LOW-THRUST INDIRECT MANEUVER ENGINE” and filed on Sep. 12, 2024, which is hereby incorporated by reference herein in its entirety.

### TECHNICAL FIELD

The present disclosure generally relates to optimizing trajectories of vehicles equipped with a low-thrust propulsion system.

### BACKGROUND

Vehicles that operate in space may have a chemical propulsion system, an electrical propulsion system, or a chemical-electrical hybrid propulsion system. For example, a vehicle with a chemical propulsion system may rely on a liquid propellant, a solid propellant, or a liquid-solid hybrid propellant that generates thrust through a chemical reaction. A vehicle with an electrical propulsion system may rely on electric heating, electric fields, or magnetic fields that generate thrust through the acceleration of propellants. Chemical propulsion systems can produce high thrusts in a given period of time, whereas electric propulsions systems can produce low thrusts in a given period of time. Thus, chemical propulsion systems are often suitable for launching vehicles or other flight operations in which a vehicle may make rapid maneuvers and/or the flight time may be short (e.g., 1 hour, 10 hours, 24 hours, etc.). On the other hand, electric propulsion systems are often suitable for transit in space (e.g., within an orbit, between orbits, etc.) in which a vehicle may not make rapid maneuvers and/or flight times may be long (e.g., 1 week, 1 month, 1 year, 5 years, etc.).

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provide a terrestrial-based system for adjusting a trajectory of an extraterrestrial vehicle, the terrestrial-based system comprising: a trajectory determination engine configured to determine one or more trajectories for the extraterrestrial vehicle, the trajectory determination engine comprising a first memory that stores first computer-executable instructions and a first processor in communication with the first memory, wherein the first computer-executable instructions, when executed by the first processor, cause the first processor to: obtain a reference trajectory for an extraterrestrial vehicle from an initial state of the extraterrestrial vehicle to a user-specified target; and provide the reference trajectory, the initial state, and the user-specified target to a trajectory simulation engine; and the trajectory simulation engine in communication with the trajectory determination engine, the trajectory simulation engine comprising a second memory that stores second computer-executable instructions and a second processor in communication with the second memory, wherein the second computer-executable instructions, when executed by the second processor, cause the second processor to simulate a plurality of flights of the extraterrestrial vehicle that each represent a computation of a different truth trajectory in which a different error is introduced such that the extraterrestrial vehicle is off-path from the reference trajectory by the respective error, wherein the first computer-executable instructions, when executed, further cause the first processor to: determine a truth trajectory for the extraterrestrial vehicle from the simulated flights that identifies estimated movement of the extraterrestrial vehicle from the initial state towards an end target, wherein the truth trajectory is a trajectory that results in the extraterrestrial vehicle reaching the user-specified target with an accuracy above an accuracy threshold; in response to the end target being different than the user-specified target, obtain a thrust profile that allows the extraterrestrial vehicle to adjust movement towards the user-specified target; and generate an enhanced truth trajectory for the extraterrestrial vehicle by combining the truth trajectory with the thrust profile, wherein the enhanced truth trajectory causes the extraterrestrial vehicle to follow the truth trajectory and implement the thrust profile to reach the user-specified target.

The terrestrial-based system of the preceding paragraph can include any sub-combination of the following features: wherein the error at least comprises orbit determination error; wherein the trajectory simulation engine is further configured to compute each of the plurality of flights according to the reference trajectory with the error; wherein the trajectory simulation engine is further configured to provide state data of the extraterrestrial vehicle and the reference trajectory to a distributed computing system to simulate each flight in the plurality of flights in parallel; wherein the trajectory determination engine is further configured to provide an interface to a user device, the interface depicting at least one of a histogram showing metrics of each flight in the plurality of flights of the extraterrestrial vehicle or a probability of each flight in the plurality of flights reaching the user-specified target; wherein the trajectory determination engine is further configured to update computing resources to perform the simulated flights; wherein updating the computing resources includes updating a library to perform computations of the simulated flights; wherein the trajectory determination engine is further configured to update the computing resources remotely.

Another aspect of the disclosure provides a method comprising: obtaining a reference trajectory for an extraterrestrial vehicle from an initial state of the extraterrestrial vehicle to a user-specified target; receiving a plurality of simulated flights that each represent a computation of a different truth trajectory in which a different error is introduced such that the extraterrestrial vehicle is off-path from the reference trajectory by the respective error; selecting one of the truth trajectories for the extraterrestrial vehicle from the simulated flights that identifies estimated movement of the extraterrestrial vehicle from the initial state towards an end target, wherein the truth trajectory is a trajectory that results in the extraterrestrial vehicle reaching the user-specified target with an accuracy above an accuracy threshold; in response to the end target being different than the user-specified target, obtaining a thrust profile that allows the extraterrestrial vehicle to adjust movement towards the user-specified target; and generating an enhanced truth trajectory for the extraterrestrial vehicle by combining the truth trajectory with the thrust profile, wherein the enhanced truth trajectory causes the extraterrestrial vehicle to follow the truth trajectory and implements the thrust profile to reach the user-specified target.

The method of the preceding paragraph can include any sub-combination of the following features: wherein the error at least comprises orbit determination error; wherein the method further comprising providing an interface to a user device, the interface depicting at least one of a histogram showing metrics of each flight in the plurality of flights of the extraterrestrial vehicle or a probability of each flight in the plurality of flights reaching the user-specified target; wherein the method further comprising updating computing resources to perform the simulated flights; wherein updating the computing resources includes updating a library to perform computations of the simulated flights; wherein the method further comprising updating the computing resources remotely.

Another aspect of the disclosure provides a non-transitory, computer-readable medium comprising computer-executable instructions for adjusting a trajectory of an extraterrestrial vehicle, wherein the computer-executable instructions, when executed by a computer system, cause the computer system to: obtain a reference trajectory for the extraterrestrial vehicle from an initial state of the extraterrestrial vehicle to a user-specified target; receive a plurality of simulated flights that each represent a computation of a different truth trajectory in which a different error is introduced such that the extraterrestrial vehicle is off-path from the reference trajectory by the respective error; select one of the truth trajectories for the extraterrestrial vehicle from the simulated flights that identifies estimated movement of the extraterrestrial vehicle from the initial state towards an end target, wherein the truth trajectory is a trajectory that results in the extraterrestrial vehicle reaching the user-specified target with an accuracy above an accuracy threshold; in response to the end target being different than the user-specified target, obtain a thrust profile that allows the extraterrestrial vehicle to adjust movement towards the user-specified target; and generate an enhanced truth trajectory for the extraterrestrial vehicle by combining the truth trajectory with the thrust profile, wherein the enhanced truth trajectory causes the extraterrestrial vehicle to follow the truth trajectory and implements the thrust profile to reach the user-specified target.

The non-transitory, computer-readable medium of the preceding paragraph can include any sub-combination of the following features: wherein the error at least comprises orbit determination error; wherein the computer-executable instructions, when executed by the computer system, further cause the computer system to provide an interface to a user device, the interface depicting at least one of a histogram showing metrics of each flight in the plurality of flights of the extraterrestrial vehicle or a probability of each flight in the plurality of flights reaching the user-specified target; wherein the computer-executable instructions, when executed by the computer system, further cause the computer system to update computing resources to perform the simulated flights; wherein updating the computing resources includes updating a library to perform computations of the simulated flights; wherein the computer-executable instructions, when executed by the computer system, further cause the computer system to update the computing resources remotely.

Another aspect of the disclosure provides a trajectory determination system comprising: a memory that stores computer-executable instructions; and a processor in communication with the memory, wherein the computer-executable instructions, when executed by the processor, cause the processor to: obtain a reference trajectory for an extraterrestrial vehicle, wherein the reference trajectory begins at an initial state of the extraterrestrial vehicle and ends at a user-specified target; obtain a truth trajectory for the extraterrestrial vehicle that identifies estimated movement of the extraterrestrial vehicle from the initial state towards the user-specified target, wherein the truth trajectory includes an error applied to the reference trajectory and causes the extraterrestrial vehicle to end at a different target than the user-specified target; separate a duration of the reference trajectory into a plurality of operational cycles, wherein each of the plurality of operational cycles represent time durations in which the extraterrestrial vehicle flies a particular trajectory before updating an onboard thrust profile based on an estimate of a state of the extraterrestrial vehicle; obtain a thrust profile for an operational cycle of the plurality of operational cycles, wherein the thrust profile causes the extraterrestrial vehicle to reach a target position along the reference trajectory at a termination of the operational cycle; apply the thrust profile to the truth trajectory for the operational cycle, wherein applying the thrust profile reduces at least some movement of the extraterrestrial vehicle due to the error.

The trajectory determination system of the preceding paragraph can include any sub-combination of the following features: wherein an initial position of the extraterrestrial vehicle for a subsequent operational cycle is an end position of the extraterrestrial vehicle for the operational cycle; wherein the computer-executable instructions, when executed, further cause the processor to obtain simulated trajectory executions for the operational cycle, wherein obtaining the simulated trajectory executions is based on a plurality of simulated flights of the extraterrestrial vehicle according to variations of the error, wherein the simulated trajectory executions provide a probability of success for the extraterrestrial vehicle to reach the user-specified target; wherein the simulated trajectory executions are Monte Carlo simulations of the extraterrestrial vehicle following the operational cycle; wherein the simulated trajectory executions are simulated in parallel; wherein the computer-executable instructions, when executed, further cause the processor to determine a probability of the extraterrestrial vehicle reaching the user-specified target based on following applications of the thrust profile to the truth trajectory; wherein the computer-executable instructions, when executed, further cause the processor to, in response to the probability being greater than a trajectory probability, select an operations architecture with the probability greater than an accuracy threshold to reach the user-specified target; wherein the computer-executable instructions, when executed, further cause the processor to: generate instructions for the operational cycle to allow the extraterrestrial vehicle to reach the target position at the termination of the operational cycle; and transmit the instructions to the extraterrestrial vehicle; wherein the computer-executable instructions, when executed, further cause the processor to: generate instructions for a subsequent operational cycle to allow the extraterrestrial vehicle to reach another target position at the termination of the subsequent operational cycle; and transmit the instructions to the extraterrestrial vehicle; wherein the operational cycle corresponds to a flight time duration of the extraterrestrial vehicle; wherein the operational cycle is between 5 and 14 days of flight time

Another aspect of the disclosure provides a method comprising: obtaining a reference trajectory for an extraterrestrial vehicle, wherein the reference trajectory begins at an initial state of the extraterrestrial vehicle and ends at a user-specified target; obtaining a truth trajectory for the extraterrestrial vehicle that identifies estimated movement of the extraterrestrial vehicle from the initial state towards the user-specified target, wherein the truth trajectory includes an error applied to the reference trajectory and causes the extraterrestrial vehicle to end at a different target than the user-specified target; separating a duration of the reference trajectory into a plurality of operational cycles, wherein each of the plurality of operational cycles represent time durations in which the extraterrestrial vehicle flies a particular trajectory before updating an onboard thrust profile based on an estimate of a state of the extraterrestrial vehicle; obtaining a thrust profile for an operational cycle of the plurality of operational cycles, wherein the thrust profile causes the extraterrestrial vehicle to reach a target position along the reference trajectory at a termination of the operational cycle; applying the thrust profile to the truth trajectory for the operational cycle, wherein applying of the thrust profile reduces at least some movement of the extraterrestrial vehicle due to the error.

The method of the preceding paragraph can include any sub-combination of the following features: wherein an initial position of the extraterrestrial vehicle for a subsequent operational cycle is an end position of the extraterrestrial vehicle for the operational cycle; wherein the method further comprising obtaining simulated trajectory executions for the operational cycle, wherein obtaining the simulated trajectory executions is based on a plurality of simulated flights of the extraterrestrial vehicle according to variations of the error, wherein the simulated trajectory executions provide a probability of success for the extraterrestrial vehicle to reach the user-specified target; wherein the simulated trajectory executions are Monte Carlo simulations of the extraterrestrial vehicle following the operational cycle; wherein the simulated trajectory executions are simulated in parallel; wherein the method further comprising determining a probability of the extraterrestrial vehicle reaching the user-specified target based on following applications of the thrust profile to the truth trajectory; wherein the method further comprising, in response to the probability being greater than a trajectory probability, selecting an operations architecture with the probability greater than an accuracy threshold to reach the user-specified target; wherein the method further comprising: generating instructions for the operational cycle to allow the extraterrestrial vehicle to reach the target position at the termination of the operational cycle; and transmitting the instructions to the extraterrestrial vehicle; wherein the method further comprising: generating instructions for a subsequent operational cycle to allow the extraterrestrial vehicle to reach another target position at the termination of the subsequent operational cycle; and transmitting the instructions to the extraterrestrial vehicle.

Another aspect of the disclosure provides a terrestrial-based system for adjusting a trajectory of an extraterrestrial vehicle. The terrestrial-based system may include a memory that stores computer-executable instructions. The terrestrial-based system may further include a processor in communication with the memory, wherein the computer-executable instructions, when executed by the processor, cause the processor to: generate a reference trajectory for an extraterrestrial vehicle; compute a design trajectory for the extraterrestrial vehicle; generate a maneuver profile of the extraterrestrial vehicle that causes the extraterrestrial vehicle to target the reference trajectory; compute trajectory estimations of the design trajectory and the maneuver profile; generate instructions for causing the extraterrestrial vehicle to travel along the design trajectory; and transmit the instructions to the extraterrestrial vehicle.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative operating environment in which a terrestrial-based computing system determines, for an extraterrestrial vehicle, a maneuver to adjust a position of the extraterrestrial vehicle to target back to a reference trajectory, according to one embodiment.

FIG. 2A is a diagram of illustrative data flows and interactions between components of the terrestrial-based computing system of FIG. 1 to determine a trajectory change for the extraterrestrial vehicle to adjust a path to target back to a reference trajectory, according to one embodiment.

FIG. 2B is a diagram of illustrative data flows and interactions between the trajectory determination system and the trajectory simulation system to determine a trajectory change for the extraterrestrial vehicle to adjust a path to target back to a reference trajectory, according to one embodiment.

FIG. 3 is a flow diagram depicting an example trajectory determination routine illustratively implemented by a terrestrial-based computing system, according to one embodiment.

FIG. 4 is an illustrative routine to enhance a trajectory of an extraterrestrial vehicle, according to one embodiment.

FIG. 5 is an illustrative routine to determine movement of an extraterrestrial vehicle during a operational cycle, according to one embodiment.

FIG. 6A illustrates an example operational cycle for an extraterrestrial vehicle, according to one embodiment.

FIGS. 6B-6E illustrate example adjustments to a trajectory for an extraterrestrial vehicle, according to one embodiment.

FIG. 7 illustrates a block diagram of an illustrative computing system configured to determine a trajectory for an extraterrestrial vehicle to target back to a reference trajectory according to some embodiments.

### DETAILED DESCRIPTION

Electric propulsion systems generally provide small maneuvers that may accumulate over a long period of time. This is because electric propulsion maneuvers are used for rapid maneuvers in collision avoidance and station keeping. The small maneuvers may result in perturbations that affect the vehicle and that cause the vehicle to veer away from the reference trajectory. The perturbations may compound over time, resulting in the vehicle straying a meaningful distance from the reference trajectory.

Determining a trajectory to account for the distance by which the vehicle may be off the reference trajectory can be difficult, however. The number of parameters involved in accurately modeling the physical environment in which the vehicle may be traveling may be extensive and it can be difficult to identify all of the various perturbations (e.g., gravitational forces, cosmic winds, solar storms, etc.) that can affect the trajectory of the vehicle between point A and point B. In addition, the time it may take a vehicle with an electric propulsion system to travel from point A to point B may be on the order of hundreds of days. Determination of the trajectory, however, may involve determining maneuvers of the vehicle second by second or minute by minute. For example, vehicles with electric propulsion have low thrust magnitude characteristics, which means that determination of the trajectory may involve determining tens of thousands of revolution transfer spirals. As a result, the amount of computational time it may take a typical computing system to attempt to model the physical environment and determine a trajectory can be very lengthy (e.g., multiple days, multiple weeks, etc.).

Additionally, the conventional approaches may determine updated trajectories with a compute time insufficient to perform the corresponding maneuvers according to an operational schedule. During flight operations, to account for maneuver execution and orbit determination errors, the trajectory and maneuvers for extraterrestrial vehicle equipped with electric propulsion must be frequently redesigned to correct for errors and ensure the extraterrestrial vehicle reaches the desired final orbit. The maneuver redesigns must be performed according to an operational schedule (for example, predetermined schedule for operating the extraterrestrial vehicle). In this way, the pre-flight operational analysis must demonstrate that the planned operations schedule and maneuver uploads can correct for the expected errors. Without insight from analysis showing the effect of the maneuver execution and orbit determination errors on the feasibility of the trajectory, the operational schedule may be unable to correct for the errors in a timely manner. Further, this pre-flight analysis may even highlight phases of the trajectory with a high chance of failure and necessitate a change in design to improve trajectory feasibility. Incorporating insight from error analysis enables a mission designer to produce trajectories, operational schedules, and mission architectures with significantly higher feasibilities when subject to expected errors.

Accordingly, the present disclosure is directed to a new process for solving trajectory computation in a manner that realizes the technical benefits of indirect optimization of maneuver profiles, determination of a design trajectory, optimization of maneuver profiles, and statistical maneuver analysis, without the technical deficiencies described above. To generate insights into the effect of maneuver execution and orbit determination errors on an electric propulsion trajectory, the systems and methods disclosed herein may generate and evaluate various electric propulsion trajectories. For an electric propulsion trajectory (such as a reference trajectory), the extraterrestrial vehicle may be subjected to errors while repeatedly targeting back to the reference trajectory. In some cases, the errors increase and prohibit the extraterrestrial vehicle from targeting back to the reference trajectory by a specified target time. In this way, the systems disclosed herein may generate a new reference trajectory for the extraterrestrial vehicle. In some cases, the systems disclosed herein may redesign the reference trajectory multiple times throughout the trajectory duration. In this way, the approaches disclosed herein allow for generation and evaluation of various operations architectures. For each operations architecture examined, the systems and methods disclosed herein compute a probability of success for designing maneuvers that the extraterrestrial vehicle performs and expected delivery errors to a particular target destination.

While the present disclosure describes a terrestrial-based computing system as executing the processes described herein, this is for illustrative purposes and is not meant to be limiting. For example, a vehicle traveling in space may include one or more processors and memory that store computer-executable instructions, where the computer-executable instructions, when executed by the processor(s), cause the processor(s) to implement the processes described herein. In this example, a vehicle itself may be able to determine trajectory updates to perform an orbital maneuver in a timely manner.

The foregoing aspects and many of the attendant advantages of this disclosure will become more readily appreciated as the same become better understood by reference to the following detailed description, when taken in conjunction with the accompanying drawings.

### Example Environment for Vehicle Trajectory Optimization

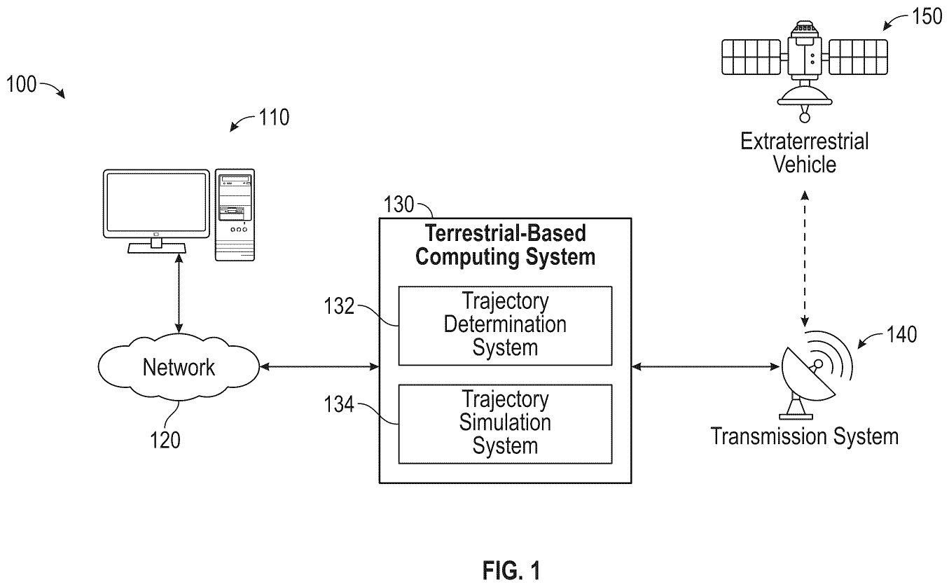

FIG. 1 is a block diagram of an illustrative operating environment 100 in which a user device 110 communicates with a terrestrial-based computing system 130 via a network 120. The terrestrial-based computing system 130 may determine, for an extraterrestrial vehicle 150, adjustments to a trajectory to perform an orbital maneuver. The extraterrestrial vehicle 150 may be a space lander (e.g., a lander configured to land on a celestial body, such as a moon, a planet, an asteroid, etc.), a rover, a rocket, a satellite, a spaceship, a space shuttle, and/or any other type of vehicle that is capable of operating in space and/or on an extraterrestrial object other than Earth. The operating environment 100 further includes a transmission system 140. The extraterrestrial vehicle 150 may also be referred to herein as “spacecraft.” As described herein, “space” may include outer space or any location outside of Earth's orbit. For example, “space” may be with respect to an extraterrestrial vehicle traveling in low-Earth orbit (LEO), geostationary orbit (GEO), or interstellar travel with or without interaction with a terrestrial-based system.

Users may use the user device 110 to interact with the terrestrial-based computing system 130, for example, to cause the extraterrestrial vehicle 150 to adjust a position. In some examples, users of the user device 110 may include engineers, data scientists, or other personnel within an organization who request computational resources for jobs such as mission control operations, product development, code execution, or other uses.

In some embodiments, the network 120 may be a publicly-accessible network of linked networks, possibly operated by various distinct parties, such as the Internet. In some cases, the network 120 may be or include a private network, personal area network, local area network, wide area network, global area network, cable network, satellite network, cellular data network, etc., or a combination thereof, some or all of which may or may not have access to and/or from the Internet. Although FIG. 1 illustrates a single network 120, the illustration is provided for purposes of example only, and is not intended to be limiting, required, or exhaustive. In some embodiments, the network 120 may include, or be in communication with, a plurality of networks. For example, the network 120 may include an internal network and a backbone network. The internal network may include a network connecting computing hardware together. In this way, the internal network may provide the computing hardware a bandwidth dedicated for computational resource usage. The backbone network may connect services between the components as illustrated in FIG. 1.

The terrestrial-based computing system 130 can be a computing system configured to generate instructions that cause an extraterrestrial vehicle 150 to travel along a certain trajectory that may minimize travel time or fuel usage when the extraterrestrial vehicle 150 is attempting to reach point B from point A while in space. The terrestrial-based computing system 130 may be a single computing device, or it may include multiple distinct computing devices, such as computer servers, logically or physically grouped together to collectively operate as a server system. The components of the terrestrial-based computing system 130 can each be implemented in application-specific hardware (e.g., a server computing device with one or more ASICs) such that no software is necessary, or as a combination of hardware and software. In addition, the modules and components of the terrestrial-based computing system 130 can be combined on one server computing device or separated individually or into groups on several server computing devices. In some embodiments, the terrestrial-based computing system 130 may include additional or fewer components than illustrated in FIG. 1.

The terrestrial-based computing system 130 may include various modules, components, data stores, and/or the like to provide the motion planning functionality described herein. For example, the terrestrial-based computing system 130 may include a trajectory determination system 132 (which may be referred to herein as trajectory determination engine) and a trajectory simulation system 134 (which may be referred to herein as trajectory simulation engine). The trajectory determination system 132 may generate a maneuver profile of the extraterrestrial vehicle 150, as disclosed herein. The trajectory determination system 134 may generate trajectory estimations from the maneuver profile, as disclosed herein. In some examples, each of the trajectory determination system 132 and the trajectory simulation system 134 may be implemented by a physical hardware machine that has one or more hardware processors, memory, and/or other physical computing components and that the hardware processor(s) can execute computer-executable instructions stored locally on the physical machine that, when executed, enable the physical hardware machine to perform the functionality described herein with respect to the respective engine. In some examples, the same physical machine or different physical machines may implement each of the trajectory determination system 132 and the trajectory simulation system 134.

The terrestrial-based computing system 130 can use modified equinoctial elements (MEEs) as a primary representation of the state of the extraterrestrial vehicle 150 relative to a central body for the operations described herein. For example, the terrestrial-based computing system 130 may calculate orbital dynamics based on known or obtained parameter values associated with the extraterrestrial vehicle 150 (e.g., the terrestrial-based computing system 130 may obtain parameter values associated with the extraterrestrial vehicle 150 from the extraterrestrial vehicle 150 itself, from one or more sensors located in space, from a separate terrestrial-based system, not shown, etc.).

The transmission system 140 may include one or more antennas, one or more radio telescopes, and/or any other transmission equipment that is capable of transmitting or beaming a signal from Earth to a vehicle, such as the extraterrestrial vehicle 150, traveling in space. As described in greater detail below, the terrestrial-based computing system 130 is configured to generate instructions that, when executed by an extraterrestrial vehicle 150, causes the extraterrestrial vehicle 150 to travel along a certain trajectory. The terrestrial-based computing system 130 may be in communication with the transmission system 140 and may transmit generated instructions to the transmission system 140 so that the transmission system 140 can transmit the generated instructions to an extraterrestrial vehicle 150 traveling in space. In some cases, in response to receiving the generated instructions, the extraterrestrial vehicle 150 may perform an action. For example, the extraterrestrial vehicle 150 may adjust an orbital trajectory in response to receiving the generated instructions. In some cases, the extraterrestrial vehicle 150 may adjust from an initial trajectory to an updated trajectory that is different than the initial trajectory.

The extraterrestrial vehicle 150 may include an electric propulsion system or a chemical-electric hybrid propulsion system. Thus, the extraterrestrial vehicle 150 may operate in a low-thrust environment. The extraterrestrial vehicle 150, however, may include an electric propulsion system, a chemical propulsion system, or a chemical-electric hybrid propulsion system. Thus, the extraterrestrial vehicle 150 may operate in a low-thrust and/or a high-thrust environment.

Example Data Flow Interactions with Terrestrial-Based Computing System

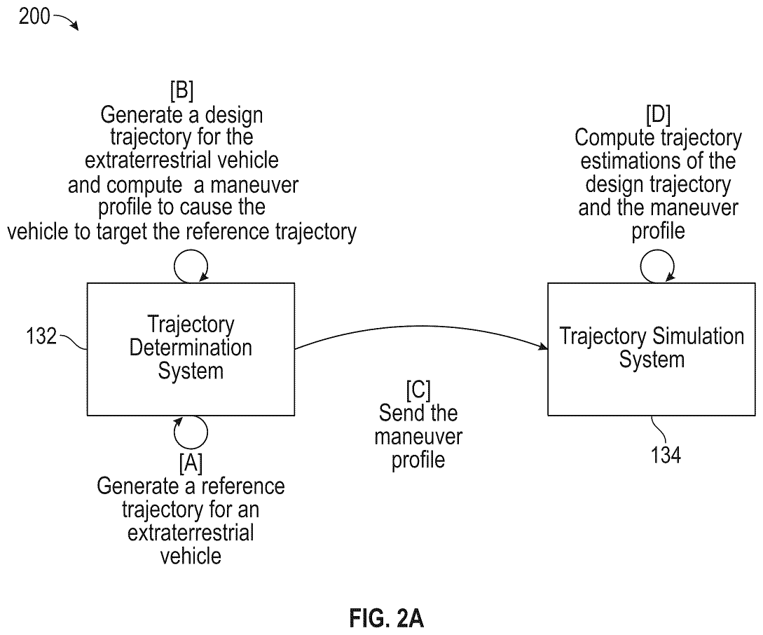

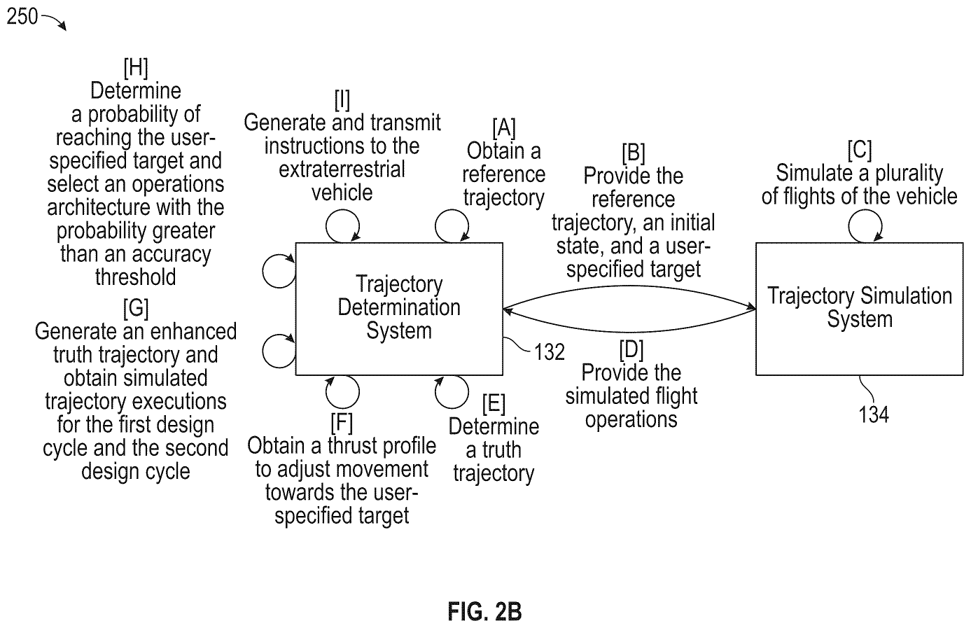

FIG. 2A is a diagram 200 of illustrative data flows and interactions between an extraterrestrial vehicle 150 and a terrestrial-based computing system 130 to determine a trajectory change for the extraterrestrial vehicle 150 to adjust an orbital path. The steps as described for FIG. 2A may be performed by components of the terrestrial-based computing system 130, such as the trajectory determination system 132 and the trajectory simulation system 134.

At [A], the trajectory determination system 132 generates a reference trajectory for an extraterrestrial vehicle (such as the extraterrestrial vehicle 150 in FIG. 1). The trajectory determination system 132 may generate the reference trajectory without including errors (for example, errors arising in motion of the extraterrestrial vehicle 150 as disclosed herein). In some examples, the reference trajectory generation (and any other maneuver profile and/or trajectory computation and generation) may be similar or identical to and/or incorporate any of the features described and/or illustrated with respect to any of the devices, assemblies, systems, and/or methods described and/or illustrated in U.S. application Ser. No. 18/793,700, filed Aug. 2, 2024, entitled “SYSTEMS AND METHODS FOR LOW-THRUST PROPULSION TRAJECTORY OPTIMIZATION USING A MINIMUM PROPELLANT TRANSFER,” U.S. application Ser. No. 18/793,696, filed Aug. 2, 2024, entitled “SYSTEMS AND METHODS FOR LOW-THRUST PROPULSION TRAJECTORY OPTIMIZATION USING A MINIMUM TIME TRANSFER,” U.S. application Ser. No. 18/793,695, filed Aug. 2, 2024, entitled “LOW-THRUST PROPULSION VEHICLE WITH TRAJECTORY OPTIMIZATION USING MINIMUM PROPELLANT TRANSFER,” and U.S. application Ser. No. 18/793,710, filed Aug. 2, 2024, entitled “LOW-THRUST PROPULSION VEHICLE WITH TRAJECTORY OPTIMIZATION USING MINIMUM TIME TRANSFER,” which are hereby incorporated by reference in its entirety and for all purposes.

At [B], the trajectory determination system 132 generates a design trajectory for the extraterrestrial vehicle 150 and computes a maneuver profile to cause the extraterrestrial vehicle 150 to target the reference trajectory. In some examples, the extraterrestrial vehicle 150 may follow a design trajectory, which may be a trajectory that causes the extraterrestrial vehicle 150 to target back to the reference trajectory. The trajectory determination system 132 may generate the design trajectory to include errors (for example, orbit determination error, maneuver execution error, launch vehicle injection errors, dynamical modeling errors, vehicle perturbation, etc. that were unaccounted for when generating the reference trajectory). In some examples, the trajectory determination system 132 may compute the design trajectory for each of a plurality of cycles.

The maneuver profile may correspond to maneuvers for the extraterrestrial vehicle 150 to perform to adjust a position towards the reference trajectory. For example, the one or more maneuvers may cause the extraterrestrial vehicle 150 to follow the design trajectory. In some cases, the maneuvers may include following the electric propulsion trajectories for an orbital maneuver, such as, orbit raising, GEO insertion, and for GEO station keeping maneuvers. In some cases, the trajectory determination system 132 may compute the maneuver profile using an indirect optimization scheme.

In some examples, the design trajectory generation and maneuver profile computation (and any other maneuver profile and/or trajectory computation and generation) may be similar or identical to and/or incorporate any of the features described and/or illustrated with respect to any of the devices, assemblies, systems, and/or methods described and/or illustrated in U.S. application Ser. No. 18/793,700, filed Aug. 2, 2024, entitled “SYSTEMS AND METHODS FOR LOW-THRUST PROPULSION TRAJECTORY OPTIMIZATION USING A MINIMUM PROPELLANT TRANSFER,” U.S. application Ser. No. 18/793,696, filed Aug. 2, 2024, entitled “SYSTEMS AND METHODS FOR LOW-THRUST PROPULSION TRAJECTORY OPTIMIZATION USING A MINIMUM TIME TRANSFER,” U.S. application Ser. No. 18/793,695, filed Aug. 2, 2024, entitled “LOW-THRUST PROPULSION VEHICLE WITH TRAJECTORY OPTIMIZATION USING MINIMUM PROPELLANT TRANSFER,” and U.S. application Ser. No. 18/793,710, filed Aug. 2, 2024, entitled “LOW-THRUST PROPULSION VEHICLE WITH TRAJECTORY OPTIMIZATION USING MINIMUM TIME TRANSFER.”

In some examples, the trajectory determination system 132 may compute the design trajectory to cause the extraterrestrial vehicle 150 to adjust towards the reference trajectory according to an operational schedule. For example, the operational schedule may be associated with a plurality of operational cycles (for example, a set number of days corresponding to a cycle of operations for the extraterrestrial vehicle 150), various phases (including an electric propulsion phase), a duty cycle (such as reference trajectory duty cycle), and maneuver upload times, among other aspects relevant for a mission architecture of operating the extraterrestrial vehicle 150. In some examples, the extraterrestrial vehicle 150 may operate according to instructions associated with the operational schedule. For example, the extraterrestrial vehicle 150 may enter an electric propulsion phase of operation, in which, the extraterrestrial vehicle 150 performs maneuvers with the electric propulsion system onboard. In this way, the extraterrestrial vehicle 150 may follow a duty cycle according to the operational schedule, which may cause the extraterrestrial vehicle 150 to operate the electric propulsion at the duty cycle (for example, between 70%-100%). The duty cycle may adjust according to the trajectory determination as described herein. For example, the reference trajectory duty cycle may vary between 85%-95%, where lower duty cycles correspond to longer flight time and lower propellant mass usage solutions and higher duty cycles produce shorter flight time and higher propellant mass usage solutions. In some cases, the duty cycle of the design trajectory may be set at 95%. The larger the gap between duty cycles, the more margin the trajectory determination system 132 has to retarget the reference trajectory once subject to errors.

In some examples, the trajectory determination system 132 may determine the maneuver profile according to a data cutoff parameter. For example, the data cutoff parameter may restrict data retrieval to a prior time period (such as, five days prior), for example, with respect to a point in time the extraterrestrial vehicle 150 entering the electric propulsion phase.

In some examples, the trajectory determination system 132 may cause the transmission system 140 to transmit instructions according to the operational schedule. For example, the trajectory determination system 132 may compute the design trajectory within a cycle duration and cause the transmission at a predetermined time within the cycle duration. In some examples, the cycle duration is on the order of seconds, minutes, hours, days, weeks, months, years, etc. The trajectory determination system 132 may compute the design trajectory at a predetermined time in each of the plurality of cycles according to the operational schedule, such as a cadence at which the trajectory determination system 132 may generate and cause the transmission system 140 to transmit. For example, for a first cycle, the extraterrestrial vehicle 150 may fly for a specified duration (such as, five days targeting the reference trajectory). After the specified duration, the trajectory determination system 132 may compute the design trajectory, as part of a new maneuver profile, and upload a new maneuver profile using state data from an orbit determination data cutoff (for example, of one day previously). In this way, the trajectory determination system 132 may follow the cadence for a number of cycles (for example, 16 cycles). In some cases, the trajectory determination system 132 may adjust the cadence, for example, increasing a cycle length to ten days due to state data of the extraterrestrial vehicle 150. For example, the trajectory determination system 132 may adjust the cadence when the state data indicates a position of the extraterrestrial vehicle 150 is closer to GEO (which may indicate decreased sensitivity to errors).

In some cases, if during any cycle, the trajectory determination system 132 is unable to retarget the reference trajectory with the design trajectory, the trajectory determination system 132 may generate a new reference trajectory and develop new maneuver profiles. In some cases, the operational schedule may include time durations of eclipses and communication windows. In this way, the trajectory determination system 132 may compute the design trajectory according to the eclipses and communication windows. The trajectory determination system 132 may compute various design trajectories across a plurality of cycles before causing the extraterrestrial vehicle 150 to adjust to the reference trajectory. This reference trajectory is developed using a duty cycle that may be varied to develop distinct solutions balancing flight time and propellant mass usage, as disclosed herein. At [C], the trajectory determination system 132 sends the maneuver profile to the trajectory determination system 134.

At [D], the trajectory determination system 134 computes trajectory estimations of the design trajectory and the maneuver profile. For example, the trajectory determination system 134 may apply statistical evaluation techniques to obtain a probability of success for the extraterrestrial vehicle 150 while targeting the reference trajectory according to the maneuver profile. The trajectory determination system 134 may obtain traversal data (for example, flight data of the extraterrestrial vehicle 150 corresponding to the data cutoff parameter) to generate statistics on the mission architecture. In some examples, the trajectory determination system 134 may apply Monte Carlo simulation to the electric propulsion trajectories (or any other trajectories associated with the extraterrestrial vehicle 150). In some cases, the trajectory determination system 134 may compute the trajectory estimations using compute resources local and/or remote to the terrestrial-based computing system 130. In some examples, after obtaining the one or more target trajectories, the terrestrial-based computing system 130 may transmit the instructions to the extraterrestrial vehicle 150. Accordingly, the extraterrestrial vehicle 150 may adjust a position in response.

FIG. 2B is a diagram 250 of illustrative data flows and interactions between components of a terrestrial-based computing system 130 to determine a trajectory change for an extraterrestrial vehicle 150 and generate and transmit instructions to the extraterrestrial vehicle 150.

At [A], the trajectory determination system 132 obtains a reference trajectory. In some examples, the trajectory determination system 132 may compute the reference trajectory, which may include a path from an initial state (such as, position and velocity) of the extraterrestrial vehicle 150 to a user-specified target. In some cases, the reference trajectory may be a path using electric propulsion that satisfies operational targets (such as a reduced (or minimum) usage of fuel, stability of angular velocity and other parameters, probability of successfully reaching the target, target duty cycle of thruster activation (such as a duty cycle between 85-95%), and/or the like). The trajectory determination system 132 may obtain the reference trajectory that tracks movement of the extraterrestrial vehicle 150 without including errors (such as the errors as described herein). In some examples, the trajectory determination system 132 may compute the reference trajectory via orbit-averaging. For example, the trajectory determination system 132 may compute changes to shape and orientation of an orbit of the extraterrestrial vehicle 150 for a predetermined quantity of revolutions of the orbit.

In some examples, the trajectory determination system 132 may compute a thrust profile for the extraterrestrial vehicle 150 to follow the reference trajectory. The trajectory determination system 132 may compute the thrust profile by applying optimal control theory (for example, indirect optimization). For example, the trajectory determination system 132 may achieve one or more user-selected objectives (such as, target position, propellant usage, transfer time, radiation, and/or the like) by determining a thruster pointing direction over time and thruster activation times. At [B], the trajectory determination system 132 provides the reference trajectory, the initial state, and the user-specified target to the trajectory simulation system 134.

At [C], the trajectory simulation system 134 determines simulated flight operations according to the reference trajectory and errors. In some examples, the trajectory simulation system 134 may simulate flights of the extraterrestrial vehicle 150 along the reference trajectory with errors. For example, the trajectory simulation system 134 computes a plurality of simulated flights, where each simulated flight may represent a computation of a different truth trajectory for a corresponding extraterrestrial vehicle from a position that is within a threshold distance of the initial state toward the user-specified target. The trajectory simulation system 134 can compute the plurality of simulated flights in parallel or overlapping in time. For each flight in the plurality of simulated flights, the trajectory simulation system 134 may introduce an error such that the corresponding extraterrestrial vehicle is off-path from the reference trajectory by the error. The errors may account for thrusters of the extraterrestrial vehicle 150 performing differently than computed in designs and thruster pointing errors causing growth in position error over time, which compounds the effects of pointing errors. For example, the trajectory simulation system 134 may determine the errors by computing standard deviations for estimated position and velocity of the extraterrestrial vehicle. The standard deviation may be between 0 and 3 (for example, 1). The trajectory simulation system 134 may generate a matrix of standard deviations for various dimensions of the extraterrestrial vehicle to represent the errors (for example, as described herein for Equation (1)). In this way, the trajectory simulation system 134 may include uncertainty in the simulated flight operations. In some cases, the trajectory simulation system 134 may generate a design trajectory (for example, for each simulated flight operation). The design trajectory may cause the extraterrestrial vehicle 150 to adjust a position from a simulated position to the reference trajectory (for example, subject to the errors).

The trajectory simulation system 134 may generate and simulate various operations architectures (for example, flight paths that the extraterrestrial vehicle 150 may travel along to target the reference trajectory, various quantities of the errors, and/or the like). An operations architecture may include extraterrestrial vehicle paths for orbit determination (OD) to successfully navigate maneuvers and/or a timeline of operations events, including OD data cutoffs (DCOs), ground process start and end times for designing maneuvers, and/or the planned duration for maneuvers to be flown onboard (such as, upload maneuvers every three days, every seven days, or at some other cadence). In some cases, the trajectory simulation system 134 may generate and simulate the operations architectures for each of the computations for the plurality of simulated flights.

In some examples, the trajectory simulation system 134 may generate the operations architectures accounting for astrodynamical factors and maneuvers. For example, the astrodynamical factors may include accelerations due to spherical harmonics, solar radiation pressure, third body gravity, drag and dynamics for perturbing forces, point mass gravity for the third bodies, a spherical body for the solar radiation pressure and Earth atmospheric drag calculations, and/or the like. In some examples, the maneuvers may include: (1) a first maneuver: Earth orbit raising maneuvers to raise semi-major axis, reduce inclination, and reduce eccentricity to an orbit slightly above GEO; (2) a second maneuver: GEO insertion maneuvers to precisely target a GEO longitudinal slot; and/or (3) a third maneuver: GEO station keeping maneuvers to maintain the defined GEO station keeping box. Either the trajectory determination system 132 or the trajectory simulation system 134 may determine the maneuvers simulated for the extraterrestrial vehicle 150, including the astrodyamical factors. In some cases, the trajectory simulation system 134 may compute the maneuvers with higher-order astrodynamical factors than the maneuvers computed by the trajectory determination system 132 (for example, the trajectory simulation system 134 may compute the maneuvers while taking into account some or all of the errors, including drag or other perturbing forces).

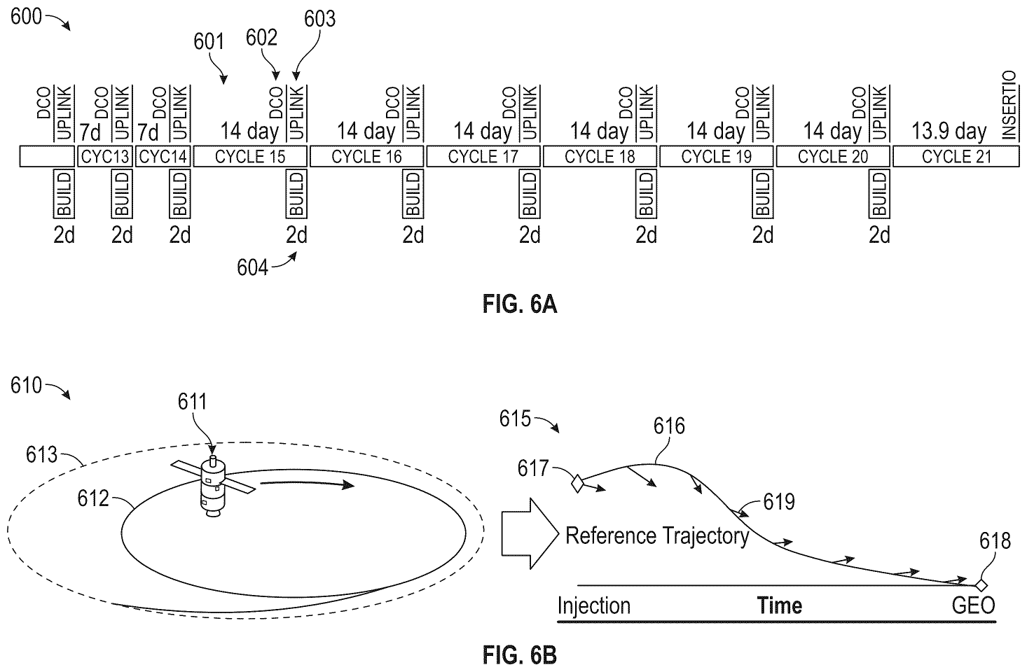

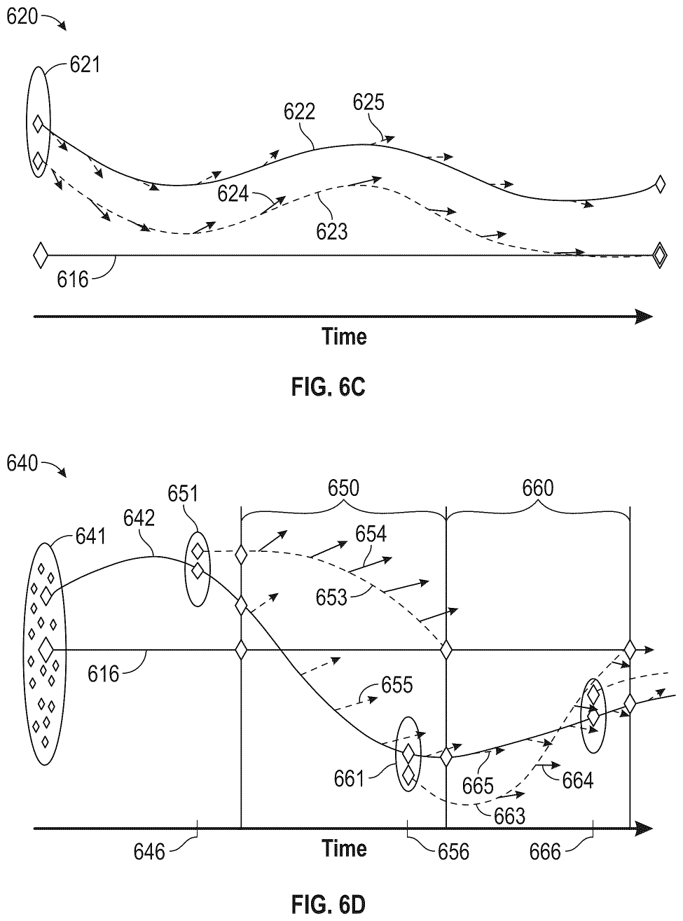

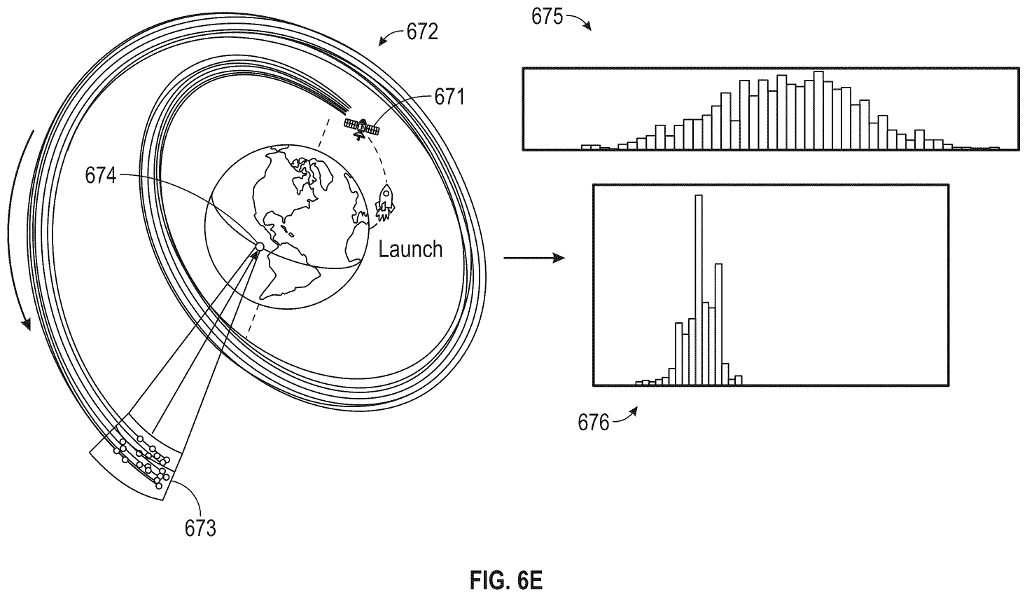

In some examples, the first maneuver may cause an extraterrestrial vehicle (such as the extraterrestrial vehicle 150) to adjust from a first position to a second position according to an electric propulsion orbit. For example, the adjustment of the position may cause the extraterrestrial vehicle 150 to be farther away from Earth, but still in a super GEO orbit (farther than GEO). In some cases, the first maneuver may be associated with a state and epoch of the extraterrestrial vehicle 150 following separation from a launch vehicle (for example, as illustrated in FIG. 6E). In some cases, the trajectory determination system 132 and/or the trajectory simulation system 134 may obtain the reference trajectory, the initial state of the extraterrestrial vehicle 150 (for example, an initial position and velocity of the extraterrestrial vehicle 150), and the final state of the extraterrestrial vehicle 150 following the maneuver (for example, the user-selected target).

In some cases, the reference trajectory may include a time-optimal reference trajectory, whereby thrust magnitude decrements by a duty cycle (such as a duty cycle selected by the user, for example, between 85%-95%). In this context, the duty cycle is a period of time for which the extraterrestrial vehicle 150 may activate thrusters. For example, the extraterrestrial vehicle 150 may activate thrusters for 85% of the period of time.

The first maneuver may result in the extraterrestrial vehicle 150 reaching the second position. The second position may be in a predetermined orbit (for example, a circular orbit, 100 km above GEO) with a geodetic longitude target (which may be determined via a back propagation from the desired GEO longitudinal slot).

The first maneuver may include two segments. The first segment may target the predetermined orbit without targeting a specific geodetic longitude. The second segment, which may begin at a time duration (such as, 50 days) prior to insertion into the predetermined orbit, may target the defined geodetic longitude.

The trajectory simulation system 134 may simulate movement of an extraterrestrial vehicle (for example, the extraterrestrial vehicle 150 and associated states of the extraterrestrial vehicle 150) to travel along the reference trajectory according to an operational cycle subject to errors (for example, the operational cycle as shown in FIG. 6A). The operational cycle is a period of time for which the extraterrestrial vehicle 150 maneuvers from an initial position to a final position (for example, a trajectory adjusting towards a reference trajectory). Multiple operational cycles may result in extraterrestrial vehicle 150 traveling in accordance with a trajectory to reach an end target.

For example, the trajectory simulation system 134 may compute the movement of an extraterrestrial vehicle (such as the extraterrestrial vehicle 150) in a first operational cycle by (i) propagating the initial state of the extraterrestrial vehicle 150 at the start of the subsequent operational cycle (for example, a second operational cycle) backwards in time for a time duration (such as 5 days, 10 days, 15 days, etc.) without errors and (ii) propagating the resulting state forward in time for a time duration (such as 5 days, 10 days, 15 days, etc.) while subject to errors (such as orbit determination errors) to determine an updated initial state of the extraterrestrial vehicle 150 at the start of the subsequent operational cycle. The initial state of the extraterrestrial vehicle 150 at the start of the subsequent operational cycle may be equivalent to the final state of the extraterrestrial vehicle 150 at the end of the first operational cycle. Therefore, propagating the initial state of the extraterrestrial vehicle 150 at the start of the subsequent operational cycle backwards in time for a time duration without errors and propagating the resulting state forward in time for a time duration while subject to errors to determine an updated initial state of the extraterrestrial vehicle 150 at the start of the subsequent operational cycle is equivalent to propagating the final state of the extraterrestrial vehicle 150 at the end of the first operational cycle backwards in time for a time duration without errors and propagating the resulting state forward in time for a time duration while subject to errors to determine an updated final state of the extraterrestrial vehicle 150 at the end of the first operational cycle. For a second operational cycle, the trajectory simulation system 134 may sample the updated initial state of the extraterrestrial vehicle 150 at a time period (such as, 1 day, 2 days, 3 days, etc.) prior to a start of the second operational cycle and propagate the state forward in time subject to the errors (such as orbit determination errors).

In some examples, for each operational cycle, the trajectory simulation system 134 may compute movement of an extraterrestrial vehicle (such as the extraterrestrial vehicle 150) to reach the final state. The final state may be based on a state of the extraterrestrial vehicle 150 according to the reference trajectory and may be some position along the reference trajectory between the first position and the second position. For example, the final state may be the state of the extraterrestrial vehicle 150 at a termination of the operational cycle. In this way, the trajectory simulation system 134 can use the initial state of the extraterrestrial vehicle 150 at the beginning of the first operational cycle and final states of each operational cycle to provide a propellant-optimal trajectory targeting the final state of the extraterrestrial vehicle 150 following a maneuver. If the trajectory simulation system 134 is unable to obtain a convergence on a feasible trajectory to the final state for a particular operational cycle, this may indicate that an updated reference trajectory should be generated in which a start of the updated reference trajectory should be a state of the extraterrestrial vehicle 150 at the beginning of the respective operational cycle. Thus, the trajectory simulation system 134 may update the reference trajectory such that the start of the reference trajectory during the respective operational cycle is a state of the extraterrestrial vehicle 150 during the respective operational cycle) and determine movement of the extraterrestrial vehicle according to the updated reference trajectory (for example, as described herein).

The second maneuver may include a reduction in orbital radius with predefined intermediate orbit targets. For example, the second maneuver may include adjusting a position of the extraterrestrial vehicle from the second position (such as in super GEO) to a third position (such as super GEO or GEO) and from the third position to a fourth position (such as GEO). In this way, there may be various types of EP maneuvers that may apply: (1) trajectory correction maneuvers (TCMs), which may target a beginning state of the transfer to GEO phase and maintain the super GEO orbit and (2) orbital trim maneuvers (OTMs), which may include short, Hohmann-like transfers that gradually lower the radius of the trajectory to GEO and target a GEO longitudinal slot.

As discussed herein, errors may compound over time and across various maneuvers for an orbit transfer. Due to the error buildup, targeting a GEO longitudinal slot directly from the super GEO orbit may be impossible with the built-up errors. In this way, the trajectory simulation system 134 may identify an intermediate orbit and incorporate the intermediate orbit for the orbit transfer, enabling a first OTM to transfer the extraterrestrial vehicle 150 from the super GEO orbit to the intermediate orbit and a second OTM to transfer the extraterrestrial vehicle 150 from the intermediate orbit to GEO. Splitting up the transfer may allow the trajectory simulation system 134 to update the second OTM to correct the error build-up during the first OTM.

To develop the geodetic longitude to target during the first maneuver, the trajectory simulation system 134 may compute the second maneuver subject to high-fidelity dynamics (such as the errors). For example, the trajectory simulation system 134 may obtain a computation of the second maneuver and (i) propagate the final state at an end of the second maneuver without errors backwards in time for a time duration (such as 5 days, 10 days, 15 days, etc.) and (ii) propagate the resulting state forward in time for a time duration (such as 5 days, 10 days, 15 days, etc.) while subject to errors (such as orbit determination errors). In some cases, the trajectory simulation system 134 may simulate the extraterrestrial vehicle 150 maintaining a position associated with a geodetic longitude in GEO (for example, at the termination of the second maneuver and at a start of the third maneuver) without errors. The trajectory simulation system 134 may estimate an epoch for maintaining the position, for example, via summing an estimated duration of the first maneuver (such as an initial epoch of the first maneuver, the expected orbit raise flight time, the time spent in the super GEO orbit) and an estimated duration of the second maneuver (such as the transfer time of the two OTMs). The trajectory simulation system 134 may simulate the second OTM, for example, via backwards propagating the extraterrestrial vehicle 150 from the fourth position to the third position (for example, the propagation may include a Hohmann-like transfer to an intermediate orbit). The second OTM may include one or more EP maneuvers that are finite EP burns in the anti-velocity direction with a predetermined thrust magnitude. In some cases, from the start of the second OTM, the trajectory simulation system 134 may propagate a coast period (such as 1 day) backwards in time to the end of the first OTM. The coast period may be as short of duration as possible while allowing for sufficient coast time to redesign the second OTM. The trajectory simulation system 134 may obtain anti-velocity EP burns (which may resemble a Hohmann-like transfer). For example, the anti-velocity EP burns may be in reverse time to target the super GEO orbit from the intermediate orbit. The trajectory simulation system 134 may propagate the state at the beginning of the first OTM in backwards time to the end of the first maneuver. In this way, the trajectory simulation system 134 may provide a set of longitudinal targets and times to target to ensure the reference trajectory is feasible.

If the GEO insertion reference trajectory is not feasible, the trajectory determination system 132 and/or the trajectory simulation system 134 may adjust (for example, iteratively) the first maneuver until the second maneuver converges in both forwards and backwards time.

In response to simulating the second maneuver, subject to orbit determination and maneuver execution errors, the trajectory simulation system 134 may separate each segment of the GEO insertion into distinct cycles (for example, according to the operational cycles). For example, the trajectory simulation system 134 may separate each individual segment into two or more operational cycles. In some cases, the trajectory determination system 132 and the trajectory simulation system 134 each may repeat the operations. For example, the operations are repeated from a start of a cycle to a start of the next cycle. In this way, the trajectory simulation system 134 may redesign maneuvers to retarget the GEO insertion reference trajectory during each cycle.

The third maneuver may ensure the extraterrestrial vehicle 150 maintains a position in orbit (for example, within a predefined GEO station keeping box centered on a defined GEO longitudinal slot). In this way, the third maneuver may include reducing deviations from target positions (for example, reducing inclination deviation from the equatorial plane and longitudinal deviation from the defined slot). In some examples, the third maneuver may include various types, including: (1) North-South maneuver to minimize inclination deviation and (2) East-West maneuver to minimize longitudinal and eccentricity deviation. These approaches allow the extraterrestrial vehicle 150 to remain nadir-pointed throughout operational activities.

In some cases, if the extraterrestrial vehicle 150 may temporarily be non-nadir-pointed during on-station activities, the trajectory determination system 132 and/or trajectory simulation system 134 may combine North-South and East-West station keeping maneuvers into a combined maneuver that corrects inclination, longitude, and eccentricity drift. Combining the maneuvers may provide: (1) designing a single type of station keeping maneuver, (2) reducing frequency of maneuvers as compared to conventional EP spacecraft, and (3) not limiting the extraterrestrial vehicle 150 architecture to the thruster configuration required for conventional EP spacecraft for GEO station keeping.

The combined maneuver enables the extraterrestrial vehicle 150 to maintain the GEO station keeping box for close to the theoretical, optimal, impulsive ΔV. In some cases, the combined maneuver may be designed such that a first combined maneuver and a second combined maneuver are separated by a predefined cadence (for example, every 1.5 days, 2 days, 2.5 days, 3 days, etc.). The trajectory determination system 132 and/or the trajectory simulation system 134 may generate the combined maneuver with a propellant cost function to reduce (in some cases, minimize) the required ΔV. The combined maneuver targets the extraterrestrial vehicle 150 back to the center of the GEO station keeping box, reducing both inclination and longitudinal deviations. In some cases, the North-South maneuver is flown out for a cycle, enabling the East-West maneuver to be redesigned to account for errors during the burn (or with the East-West maneuver flown out for a cycle and the North-South maneuver redesigned).

The trajectory simulation system 134 may include orbit determination and maneuver execution errors in flight simulations to determine the feasibility of the extraterrestrial vehicle 150 adjusting an orbit subject to errors. The trajectory simulation system 134 may apply the orbit determination errors to the state of the extraterrestrial vehicle 150 at the start of every build cycle (for example, each cycle of the operational cycles) using Equation (1). The root-sum-square (RSS) position and velocity error may form a covariance matrix and σ=\sqrt{(RSS²/3)} computes σ_{Pos} and σ_{Vel} for the position and velocity standard deviations, respectively, for each state component. The perturbed state is generated via Equation (2), where chol(M_{OD}) denotes the lower Cholesky decomposition of the covariance matrix, \vec{n}_{N(0,1),6} is a six element vector sampled from a normal distribution of mean 0 and standard deviation of 1, and \vec{x}ₜᵣᵤₜₕ and \vec{x}_{des} are the truth and design states of the extraterrestrial vehicle 150, respectively.

$${M}_{OD} = [ \begin{matrix}{σ}_{Pos , X} & 0 & 0 & 0 & 0 & 0 \\ 0 & {σ}_{Pos , Y} & 0 & 0 & 0 & 0 \\ 0 & 0 & {σ}_{Pos , Z} & 0 & 0 & 0 \\ 0 & 0 & 0 & {σ}_{Vel , X} & 0 & 0 \\ 0 & 0 & 0 & 0 & {σ}_{Vel , Y} & 0 \\ 0 & 0 & 0 & 0 & 0 & {σ}_{Vel , Z}\end{matrix} ] \qquad ( 1 )$$

$${\vec{x}}_{truth} = chol ( {M}_{OD} ) * {\vec{n}}_{N ( 0 , 1 )} + {\vec{x}}_{des} \qquad ( 2 )$$

For the maneuver execution errors, the trajectory simulation system 134 may obtain a nominal maneuver profile, for example, prior to simulating the trajectory using higher-fidelity dynamics (such as the errors). The trajectory simulation system 134 may combine the errors to the thrust magnitude and to direction to simulate maneuver execution errors. For example, the trajectory simulation system 134 may add the errors to values of the thrust magnitude and to the direction. In this way, the added errors may adjust a position of the extraterrestrial vehicle 150. The trajectory simulation system 134 may sample the maneuver execution errors to simulate both short- and long-term errors (such as stochastic errors and bias, throughout an EP maneuver). For example, the trajectory simulation system 134 may identify a target time duration for which to simulate errors (the target time duration may be short-term, long-term, or another duration). Short-term time duration may be within a cycle according to the operational cycle. The long-term time duration may span one or more cycle according to the operational cycle. Thrust magnitude errors are used to form Equation (3), where d_{T}, d_{Ra}, and d_{Dec} denote the thrust magnitude, right ascension, and declination errors, respectively, σ_{T} and σ_{Dec} are the standard deviations for a Gaussian distribution, θ_{Ra} is the right bound of a uniform distribution, and N and U denote random Gaussian and uniform distributions that are periodically sampled to model stochastic errors. The trajectory simulation system 134 may compute the maneuver execution errors using Equations (4)-(5), where \vec{u}ₙₒₘ is the nominal thrust vector, ûₙₒₘ is the unit direction vector of the nominal thrust direction, and \vec{u}ₚₑᵣₜ is the perturbed thrust direction. The thrust magnitude errors are added to the nominal thrust vector to perturb both direction and thrust magnitude to simulate both short- and long-frequency errors.

$$[ \begin{matrix}{d}_{T} \\ {d}_{Ra} \\ {d}_{Dec}\end{matrix} ] = [ \begin{matrix}𝒩 ( 0 , {σ}_{T} ) \\ 𝒰 ( 0 , {θ}_{Ra} ) \\ 𝒩 ( 0 , {σ}_{Dec} )\end{matrix} ] \qquad ( 3 )$$

$$\hat{x} = \frac{[ 0 , 0 , 1 ] \times {\hat{u}}_{nom}}{\vert ( [ 0 , 0 , 1 ] \times {\hat{u}}_{nom} ) \vert} \qquad ( 4 )$$

$$\hat{y} = \hat{z} \times \hat{x} \qquad ( 5 )$$

$$\hat{z} = {\hat{u}}_{nom} \qquad ( 6 )$$

$${\vec{u}}_{pert} = {\vec{u}}_{nom} + ( 1 + {d}_{T} ) * \vert {\vec{u}}_{nom} \vert * ( ( sin ( {d}_{Dec} ) * cos ( {d}_{Ra} ) * \hat{x} ) + ( sin ( {d}_{Dec} ) * sin ( {d}_{Ra} ) * \hat{y} ) + ( cos ( {d}_{Dec} ) * \hat{z} ) \qquad ( 7 )$$

The trajectory simulation system 134 may compute simulated flight operations for the extraterrestrial vehicle 150 according to the first, second, and/or third maneuvers, and the errors. The simulated flight operations may include state data for the extraterrestrial vehicle 150 across various scenarios (such as changing dynamics and/or states). For example, for a first cycle, the trajectory simulation system 134 may compute dynamics applied to the extraterrestrial vehicle 150 for various states (such as position and velocity). The trajectory simulation system 134 may compute the simulated flight operations by iterating values of the dynamics and/or the states according to Equation (7). In this way, for each cycle of the operational cycles, the trajectory simulation system 134 may obtain a corresponding simulated flight operation to estimate movement of the extraterrestrial vehicle 150. Returning to FIG. 2B, the trajectory simulation system 134 provides the simulated flight operations to the trajectory determination system 132 at [D].

At [E], the trajectory determination system 132 selects one of the truth trajectories computed at [C]. In some examples, the truth trajectory is a path the extraterrestrial vehicle 150 follows when attempting to travel from the initial state towards the user-specified target. For example, the trajectory determination system 132 may select the truth trajectory from one of the paths (for example, truth trajectories) produced in the simulated flight operations. As another example, the trajectory simulation system 134 may identify the truth trajectory that results in the extraterrestrial vehicle 150 reaching the user-specified target at a likelihood above a threshold (for example, 80%, 85%, 90%, etc. success of reaching the user-specified target). In some cases, the trajectory simulation system 134 may identify and select the truth trajectory that has the highest likelihood of resulting in the extraterrestrial vehicle 150 reaching the user-specified target.

At [F], the trajectory determination system 132 obtains a thrust profile to adjust movement of the extraterrestrial vehicle 150 towards the user-specified target. The trajectory determination system 132 can obtain a thrust profile for each operational cycle. The thrust profile may be a plurality of instructions about when and by how much, during an operational cycle, to activate thrusters of the extraterrestrial vehicle 150 to adjust a position towards a target (such as the user-specified target, each target for a designated cycle of the operational cycle, and/or the like). For example, the thrust profile may include vectors along the selected truth trajectory that correspond to the instructions and magnitude to reach the target. In some examples, the trajectory determination system 132 may generate the thrust profile by comparing the reference trajectory with the selected truth trajectory and identifying differences in states of the extraterrestrial vehicle 150. For example, the selected truth trajectory may indicate that the extraterrestrial vehicle 150 is to be at a first position at an end of the first cycle. The first position may be offset from a second position along the reference trajectory at the same time period (end of the first cycle). The trajectory determination system 132 may compute thrust values and timing for which the extraterrestrial vehicle 150 may follow to align a path from the selected truth trajectory with the reference trajectory. For example, the trajectory determination system 132 may compute a thrust (magnitude and direction) for which the extraterrestrial vehicle 150 may align with the second position. In some examples, the trajectory determination system 132 may receive the thrust profile from another system (for example, the trajectory simulation system 134).

At [G], the trajectory determination system 132 generates an enhanced truth trajectory and obtains simulated trajectory executions for both the first operational cycle and the second operational cycle. In general, the trajectory determination system 132 generates an enhanced truth trajectory for each operational cycle. The enhanced truth trajectory may be the selected truth trajectory adjusted according to a thrust profile. In other words, the enhanced truth trajectory is an updated version of the selected truth trajectory that results from the thrust profile adjusting a position of the extraterrestrial vehicle 150 to target back to the reference trajectory. The thrust profile may include thrust values, timing of activating thrusters of the extraterrestrial vehicle 150, and/or the like. The thrust profile may cause the extraterrestrial vehicle 150 to adjust a position from a position along the selected truth trajectory towards a user-specified position.

The trajectory determination system 132 may obtain new maneuver plans to retarget the reference trajectory according to an operational cycle (for example, every set number of days). An operational cycle may be the amount of time the extraterrestrial vehicle 150 performs onboard sequences before receiving the next sequence (for a next cycle). The goal of the operational cycles may be to have cycles be as long as possible to allow for fewer updates (for example, ground-based updates) while still achieving a desired delivery accuracy.

The operational cycle may include various cycles (for example, as shown in FIG. 6A). Each cycle may include time durations to perform various tasks. For example, the tasks may include the trajectory determination system 132 identifying an orbit determination data cutoff (such as a time period in which to receive data regarding orbit determination), an uplink duration (such as a time period in which the terrestrial-based computing system 130 can send instructions), and a build duration (such as a time period for the terrestrial-based computing system 130 to determine a trajectory associated with the extraterrestrial vehicle 150).

In some examples, the trajectory determination system 132 may separate a duration of the reference trajectory into a first operational cycle and a second operational cycle. The first operational cycle and the second operational cycle may represent time durations in which the extraterrestrial vehicle 150 flies a particular trajectory before updating onboard thrust profile based on an estimate of a state (such as, position, velocity, and/or the like) of the extraterrestrial vehicle 150.

The trajectory determination system 132 may obtain a first thrust profile for the first operational cycle. The first thrust profile may cause the extraterrestrial vehicle 150 to reach a first target position along the reference trajectory at a termination of the first operational cycle. The trajectory determination system 132 may apply the first thrust profile to the truth trajectory for the first operational cycle. The application of the first thrust profile may reduce at least some movement of the extraterrestrial vehicle 150 away from the reference trajectory due to the errors.

The trajectory determination system 132 may obtain a second thrust profile for the second operational cycle. The second thrust profile may cause the extraterrestrial vehicle 150 to reach a second target position along the reference trajectory at a termination of the second operational cycle. The trajectory determination system 132 may apply the second thrust profile to the truth trajectory for the second operational cycle. The application of the second thrust profile reduces at least some movement of the extraterrestrial vehicle 150 away from the reference trajectory due to the errors.

At [H], the trajectory determination system 132 determines a probability of reaching the user-specified target and selects an operations architecture with the probability greater than an accuracy threshold. In some examples, the trajectory determination system 132 may simulate flight operations of the extraterrestrial vehicle 150 according to the operational schedule. In some cases, the trajectory determination system 132 may simulate flight operations for multiple operational cycles to determine movement of the extraterrestrial vehicle 150 for reaching a target (such as the user-specified target).

In some examples, the trajectory determination system 132 may obtain the simulated flight operations from another system (for example, the trajectory simulation system 134). The simulations may include Monte Carlo simulations of the flight operations. In some cases, the simulations may be executed in parallel, for example, by using cloud-based resources. The cloud-based resources may allow for a single computing environment, for example, that is version-controlled using Infrastructure-as-Code (IaC) files. In this way, the users may interact with data and software of the simulated flight operations in a consistent manner. The trajectory determination system 132 and/or the trajectory simulation system 134 may perform simulated flight operations with many (such as thousands) of concurrent tasks and generate data for post-processing in a time-efficient manner. Executing thousands of concurrent tasks, for example, allows generation of enough analytical samples to yield statistically significant results, doing in one day what would take months to years without concurrent runs.

The simulated flight operations may provide state data of the extraterrestrial vehicle 150. For example, the data may include position, velocity, flight time, propellant margin (for example, to cover uncertainties), and/or the like. The trajectory determination system 132 may provide an interface that displays data associated with the aspects as described herein. For example, the interface may display a statistical distribution of the simulated flight operations, a histogram showing accuracies of the simulated flight operations of the extraterrestrial vehicle 150, and/or a probability of the simulated flight operations reaching the user-specified target, and/or the like.

At [I], the trajectory determination system 132 generates and transmits instructions to the extraterrestrial vehicle 150. The instructions may include any of the features as described herein. For example, the instructions may include the thrust profile for the extraterrestrial vehicle 150 to activate thrusters, the truth trajectory, the reference trajectory, and/or the like. In this way, the instructions may cause the extraterrestrial vehicle 150 to adjust a position to follow the truth trajectory.

### Example Trajectory Determination Routine

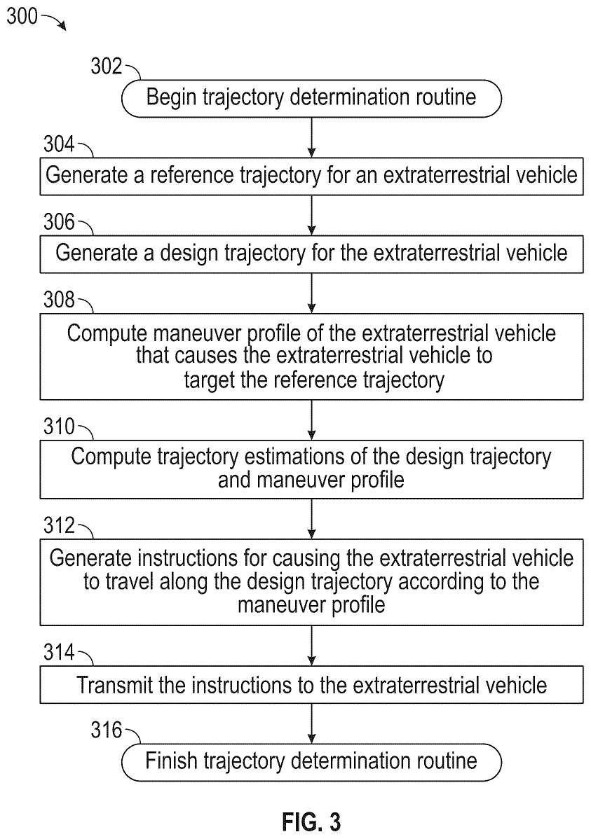

FIG. 3 is a flow diagram depicting an example trajectory determination routine 300 illustratively implemented by a terrestrial-based computing system, according to one embodiment. As an example, the terrestrial-based computing system 130 of FIG. 1 can be configured to execute the trajectory determination routine 300. The trajectory determination routine 300 begins at block 302.

At block 304, the terrestrial-based computing system 130 generates a reference trajectory for an extraterrestrial vehicle, as described herein. In some cases, the input may be an execution from a user device (for example, user device 110 in FIG. 1). The design trajectory may be an adjustment to a position of the extraterrestrial vehicle that causes the extraterrestrial vehicle to target back to a reference trajectory.

At block 306, the terrestrial-based computing system 130 computes a design trajectory for the extraterrestrial vehicle, as described herein. In some examples, the design trajectory may be a trajectory that causes the extraterrestrial vehicle 150 to target back to the reference trajectory. The terrestrial-based computing system 130 may generate the design trajectory to include errors (for example, orbit determination error, vehicle perturbation, etc. that were unaccounted for when generating the reference trajectory). In some examples, the terrestrial-based computing system 130 may compute the design trajectory for each of a plurality of cycles.

At block 308, the terrestrial-based computing system 130 generates a maneuver profile of the extraterrestrial vehicle 150 that causes the extraterrestrial vehicle 150 to target the reference trajectory, as described herein. The maneuver profile may include maneuvers for the extraterrestrial vehicle 150 to perform as disclosed herein. For example, the one or more maneuvers may include following electric propulsion trajectories for an orbital maneuver, such as, orbit raising, GEO insertion, and for GEO station keeping maneuvers. In some cases, the trajectory determination system 132 may compute the maneuver profile using an indirect optimization scheme.

At block 310, the terrestrial-based computing system 130 computes trajectory estimations of the design trajectory and the maneuver profile, as described herein. For example, the terrestrial-based computing system 130 may apply statistical evaluation techniques to obtain a probability of success for the extraterrestrial vehicle 150 while targeting the reference trajectory according to the maneuver profile as disclosed herein. For example, the trajectory determination system 134 may obtain traversal data (for example, flight data of the extraterrestrial vehicle 150 corresponding to the data cutoff parameter) to generate statistics on the mission architecture. In some examples, the trajectory determination system 134 may apply Monte Carlo simulation to the electric propulsion trajectories (or any other trajectories associated with the extraterrestrial vehicle 150). In some cases, the trajectory determination system 134 may compute the trajectory estimations using compute resources local and/or remote to the terrestrial-based computing system 130.

At block 312, the terrestrial-based computing system 130 generates instructions for causing the extraterrestrial vehicle to travel along the design trajectory, as described herein. In some examples, the instructions may cause the extraterrestrial vehicle 150 to adjust a position to follow the design trajectory and perform the maneuvers identified by the maneuver profile.

At block 314, the terrestrial-based computing system 130 transmits the instructions, for example, to the extraterrestrial vehicle. In some examples, the instructions may cause the extraterrestrial vehicle to adjust trajectory based on the generated instructions. After the instructions are transmitted to the extraterrestrial vehicle, the trajectory determination routine 300 ends, as shown at block 316.

In the above description of FIG. 3, any blocks described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

### Example Trajectory Enhancement Routine

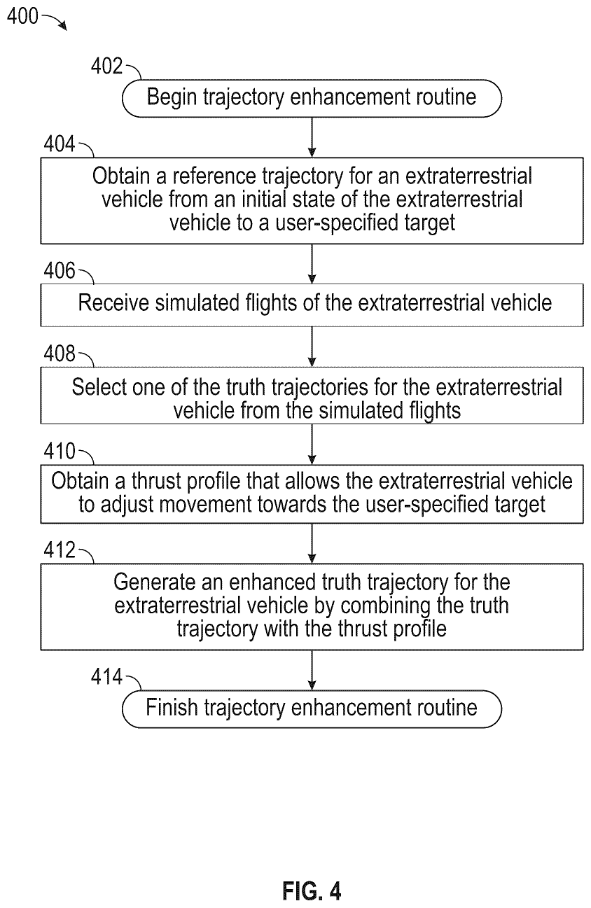

FIG. 4 is a flow diagram depicting an example trajectory enhancement routine 400 illustratively implemented by a terrestrial-based computing system, according to one embodiment. As an example, the terrestrial-based computing system 130 of FIG. 1 can be configured to execute the trajectory enhancement routine 400. The trajectory enhancement routine 400 begins at block 402.

At block 404, the terrestrial-based computing system 130 obtains a reference trajectory for an extraterrestrial vehicle 150 from an initial state of the extraterrestrial vehicle 150 to a user-specified target. The reference trajectory may be a predetermined trajectory for the extraterrestrial vehicle 150 to follow to reach an end target. For example, the reference trajectory may start from an initial position of the extraterrestrial vehicle 150 and end at a final position that may be in a different gravitational orbit than the initial position.

At block 406, the terrestrial-based computing system 130 receives simulated flights of the extraterrestrial vehicle 150. The simulated flights may each represent a computation of a truth trajectory for a corresponding extraterrestrial vehicle in which an error is introduced such that the corresponding extraterrestrial vehicle is off-path from the reference trajectory by the error. For example, the truth trajectory of a simulated flight may be the path that the extraterrestrial vehicle is simulated to take to move from the initial state towards an end target (such as the user-specified target). In some cases, the computations of the truth trajectories may execute in parallel and/or overlapping in time. For example, the terrestrial-based computing system 130 may execute the computations in parallel in a cloud-based environment. The cloud-based environment allows for simulating thousands of concurrent tasks and generate data for post-processing.

At block 408, the terrestrial-based computing system 130 selects one of the truth trajectories for the extraterrestrial vehicle 150 from the simulated flights. In some cases, the truth trajectory that is selected may be a trajectory that results in the extraterrestrial vehicle 150 reaching the user-specified target with a likelihood above a target threshold (for example, greater than 75%, 85%, 95%, 99%, etc.).

At block 408, the terrestrial-based computing system 130 obtains a thrust profile that allows the extraterrestrial vehicle 150 to adjust movement towards the user-specified target, as described herein. In some cases, the terrestrial-based computing system 130 may obtain the thrust profile in response to the end target being different than the user-specified target.

At block 410, the terrestrial-based computing system 130 generates an enhanced truth trajectory for the extraterrestrial vehicle 150 by combining the truth trajectory with the thrust profile, as described herein. In some examples, the enhanced truth trajectory may cause the extraterrestrial vehicle 150 to follow the truth trajectory and implement the thrust profile to reach the user-specified target. After the instructions are transmitted to the extraterrestrial vehicle 150, the trajectory enhancement routine 400 ends, as shown at block 412.

In the above description of FIG. 4, any blocks described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

### Example Operational Cycle Determination Routine

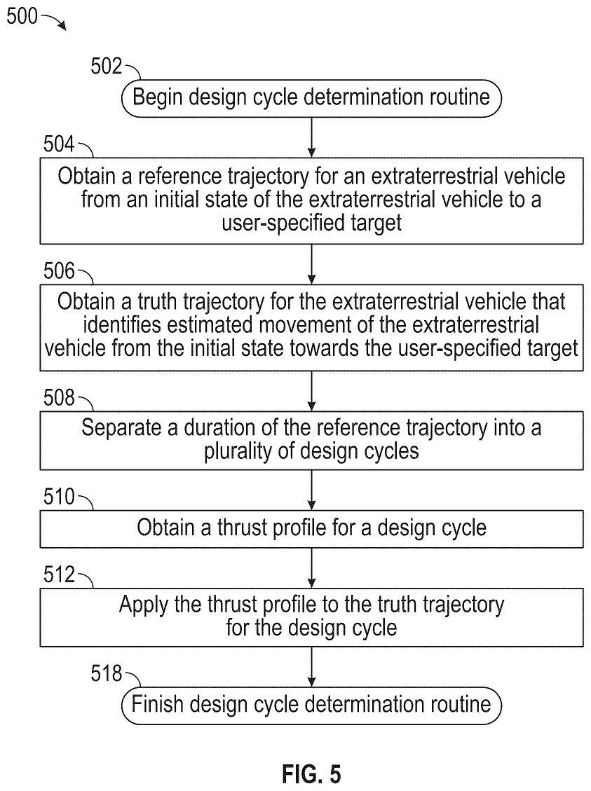

FIG. 5 is a flow diagram depicting an example operational cycle determination routine 500 illustratively implemented by a terrestrial-based computing system, according to one embodiment. As an example, the terrestrial-based computing system 130 of FIG. 1 can be configured to execute the operational cycle determination routine 500. The trajectory determination routine 500 begins at block 502.

At block 504, the terrestrial-based computing system 130 obtains a reference trajectory for an extraterrestrial vehicle from an initial state of the extraterrestrial vehicle to a user-specified target. The truth trajectory may include an error applied to the reference trajectory and causes the extraterrestrial vehicle 150 to end at a different target than the user-specified target. In some cases, the terrestrial-based computing system 130 may generate the reference trajectory based on input from a user device. For example, identifying a path from an initial position to a user-specified position. The terrestrial-based computing system 130 may receive the reference trajectory for the extraterrestrial vehicle 150 from a ground-based system where the reference trajectory begins at the initial state of the extraterrestrial vehicle and ends at the user-specified target, as disclosed herein (for example, the terrestrial-based computing system 130 in FIG. 1).

At block 506, the terrestrial-based computing system 130 obtains a truth trajectory for the extraterrestrial vehicle, as described herein. The truth trajectory may include estimated movement of the extraterrestrial vehicle 150 from the initial state towards the user-specified target.

At block 508, the terrestrial-based computing system 130 separates a duration of the reference trajectory into a plurality of operational cycles. In some cases, each of the plurality of operational cycles may represent time durations in which the extraterrestrial vehicle 150 flies a particular trajectory before updating an onboard thrust profile based on an estimate of a state of the extraterrestrial vehicle 150.

At block 510, the terrestrial-based computing system 130 obtains a thrust profile for the operational cycle. The thrust profile may cause the extraterrestrial vehicle 150 to reach a target position along the reference trajectory at a termination of the operational cycle.

At block 512, the terrestrial-based computing system 130 applies the thrust profile to the truth trajectory for the operational cycle (for example, combines the thrust profile with the truth trajectory). In some cases, applying the thrust profile may reduce at least some movement of the extraterrestrial vehicle 150 due to the error. After the terrestrial-based computing system 130 applies the thrust profile, the trajectory enhancement routine 500 ends, as shown at block 518.

In the above description of FIG. 5, any blocks described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

FIG. 6A shows an example operations schedule 600 for an extraterrestrial vehicle to navigate a trajectory, for example, to reach a particular GEO slot. The trajectory determination system 132 and/or the trajectory simulation system 134 as disclosed herein may simulate truth trajectories for a corresponding extraterrestrial vehicle and various architectures and determine that one or more of the truth trajectories has a probability (such as 95%, 98%, 99%, etc. feasibility) for delivering the extraterrestrial vehicle (such as extraterrestrial vehicle 150, 611) to GEO in accordance with the operations schedule 600 with no corrective strategies. The example operations schedule 600 illustrates timing for uploading maneuvers to the extraterrestrial vehicle 611 and the risk profile of different operations strategies.

For example, box 601 represents a single operational cycle in which the extraterrestrial vehicle 611 is flying in accordance with a previously-generated maneuver profile. Box 604 denotes a build time during which the maneuver profile for the next operational cycle (e.g., operation cycle 16) is generated using the state of the extraterrestrial vehicle 611 at the start of the build time. The build time may be the time required from the ground operations to design each maneuver. The build time may include the time from the orbit determination data cut-off (for example, at box 602) to the time at which the thrust sequence update for the next operational cycle is on-board the extraterrestrial vehicle 611. The extraterrestrial vehicle 611 is assumed to be injected into the electric propulsion phase of the mission with errors, and the first maneuver profile is built using an orbit determination data cutoff of 14 days (or any other number of days) prior to the injection into the electric propulsion phase. The number of days for the initial operational cycles (such as, 7 days, 14 days, 21 days, etc.) is selected following numerous simulated flight operations to identify an operational cycle length that balances less frequent maneuver profile updates with staying close to the reference trajectory and limiting reference trajectory redesigns. As illustrated in FIG. 6A with respect to operational cycle 15, the thrust sequence is designed by targeting a state on the reference trajectory 14 days (or any other number of days) into the future. The resulting 14-day (or any other number of day) thrust sequence is then uplinked to the extraterrestrial vehicle 611 and the extraterrestrial vehicle 611 is flown out open-loop (for example, at box 603). After 14 days (or any other number of days that defines the length of an operational cycle), a new maneuver profile is uploaded using state knowledge from an orbit determination data cutoff of a prior operational cycle. As illustrated in FIG. 6A, this cadence continues for 21 operational cycles, at which point the cycle length may increase, decrease, remain the same, end, and/or the like. While FIG. 6A depicts 21 operational cycles, this is not meant to be limiting. Any number of operational cycles may be implemented prior to any changes to the cycle length being made.

If during an operational cycle the trajectory determination system 132 and/or the trajectory simulation system 134 as described herein may be unable to retarget the reference trajectory (for example, due to insufficient thrust magnitude, time, propellant mass, and/or the like), a new reference trajectory is designed to GEO and used to develop targets for future maneuver profiles. The redesign process may occur at higher reference trajectory duty cycles because the systems herein have less margin to retarget the reference trajectory once the design trajectory is subject to errors. However, by redesigning the reference trajectory, eclipses and communication windows that may have been planned a priori may shift, potentially requiring additional analysis not explored in this investigation.

FIGS. 6B-6D illustrate the reference trajectory targeting and redesign process. As illustrated in FIG. 6B, an example orbit maneuver 610 includes an extraterrestrial vehicle 611 following a first orbit 612 and adjusting position to a second orbit 613. The adjustment of position corresponds to a reference trajectory profile 615, including a reference trajectory 616 (as disclosed herein). The reference trajectory 616 may include an initial state 617 and a final state 618 (for example, the user-specified target). The reference trajectory 616 includes various thrust vectors 619 which may signify a magnitude and direction of applied thrust for the extraterrestrial vehicle 611 to produce to follow the reference trajectory 616.

FIG. 6C illustrates an example orbit adjustment 620. The orbit adjustment 620 may include the reference trajectory 616, a set of extraterrestrial vehicle starting positions 621, a first trajectory 622, and a second trajectory 623. The set of extraterrestrial vehicle starting positions 621 may represent various extraterrestrial vehicles (such as the extraterrestrial vehicle 611) at different starting positions. The different starting positions may be due to OD error. In some examples, a first extraterrestrial vehicle may follow the first trajectory 622 that results in the vehicle reaching a first end position that may be different than an end position of the reference trajectory 616. A second extraterrestrial vehicle may follow the second trajectory 623 that results in the vehicle reaching a second end position that may reach the end position of the reference trajectory 616 (at least with an accuracy above a target threshold, for example, 90% likelihood of reaching the reference trajectory 616 end position). The first trajectory 622 may include thrust vectors 625 that, in response to execution by the extraterrestrial vehicle, may allow the extraterrestrial vehicle (such as extraterrestrial vehicle 611) to adjust movement from the starting position towards the first end position. Similarly, the second trajectory 623 may include thrust vectors 624 that may allow the extraterrestrial vehicle (such as extraterrestrial vehicle 611) to adjust a position from the starting position towards the second end position. In some cases, an extraterrestrial vehicle may have a greater likelihood of reaching the end position of the reference trajectory 616 if the extraterrestrial vehicle follows the second trajectory 623.

FIG. 6D shows example operation profile 640, including adjustments for the extraterrestrial vehicle 611 to make across various cycles for a truth trajectory. The operation profile 640 may include the reference trajectory 616, a zone of initial states 641, a truth trajectory 642, a first ground processing duration 646, a first cycle 650, a first design state 651, a first design trajectory 653, first design thrust vectors 654, first truth thrust vectors 655, a second ground processing duration 656, a second cycle 660, a second design state 661, a second design trajectory 663, second design thrust vectors 664, second truth thrust vectors 665, a third ground processing duration 666. The trajectory determination system 132 and/or the trajectory simulation system 134 described herein may successfully retarget the truth trajectory 642 in the first cycle 650, but may overshoot a target position and redesign the truth trajectory in the second cycle 660.

FIG. 6E illustrates an example orbital transfer for the extraterrestrial vehicle 671. In some examples, a terrestrial-based computing system (such as terrestrial-based computing system 130) may sample data associated with the extraterrestrial vehicle 150 for a Monte Carlo analysis, large numbers of high fidelity samples of states of the extraterrestrial vehicle 671 are collected to generate statistics on the mission architecture. In some cases, the terrestrial-based computing system (for example, terrestrial-based computing system 130) may execute instructions with remote computing resources to execute trajectory determinations based on the collected samples. For example, the remote computing resources may include cloud-based platforms that enable scaling the number of hardware processors used for executing the trajectory determinations. In some examples, the terrestrial-based computing system may provide an interface for a user-readable format. For example, the user-readable format may include one or more graphical representations of the trajectories, such as one or more histograms of the trajectories. The histograms may include on an x-axis a number associated with different trajectory simulations and on a y-axis a likelihood of the extraterrestrial vehicle 671 reaching a target position.

### Example Computing Device

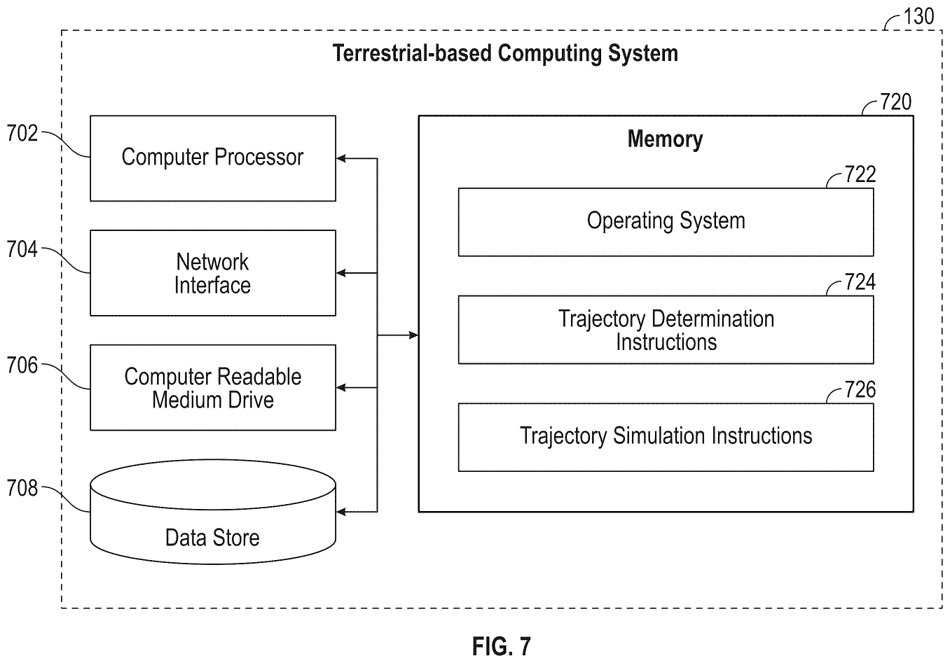

FIG. 7 illustrates various components of an example computing device configured to implement various functionality of the terrestrial-based computing system 130. In some embodiments, as shown, the terrestrial-based computing system 130 may include: one or more computer processors 402, such as physical central processing units (“CPUs”); one or more network interfaces 404, such as a network interface cards (“NICs”); one or more computer-readable medium drives 406, such as a high density disk (“HDDs”), solid state drives (“SSDs”), flash drives, and/or other persistent non-transitory computer-readable media; one or more data store 408, such as physical storage and/or remote storage, and/or other data storage components; and one or more computer-readable memories 420, such as random access memory (“RAM”) and/or other volatile non-transitory computer-readable media.

The computer-readable memory 420 may include computer program instructions that one or more computer processors 402 execute in order to implement one or more embodiments. The computer-readable memory 420 can store an operating system 422 that provides computer program instructions for use by the computer processor(s) 402 in the general administration and operation of the terrestrial-based computing system 130. In some embodiments, the computer-readable memory 420 can further include computer program instructions and other information for implementing aspects of the present disclosure. For example, the computer-readable memory 420 may include maneuver profile instructions 424 for generating maneuver profiles, as described herein. As another example, the computer-readable memory 420 may include trajectory estimation instructions 426 for evaluating trajectories, as described herein. When a routine is initiated, a corresponding set of executable program instructions stored on a computer-readable medium drive 406 may be loaded into computer-readable memory 420 and executed by one or more computer processors 402. In some embodiments, a routine—or portions thereof—may be implemented on multiple computing devices and/or multiple processors, serially or in parallel.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements, or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A trajectory determination system comprising:
a memory that stores computer-executable instructions; and
a processor in communication with the memory, wherein the computer-executable instructions, when executed by the processor, cause the processor to:
obtain a reference trajectory for an extraterrestrial vehicle, wherein the reference trajectory begins at an initial state of the extraterrestrial vehicle and ends at a user-specified target;
obtain a truth trajectory for the extraterrestrial vehicle that identifies estimated movement of the extraterrestrial vehicle from the initial state towards the user-specified target, wherein the truth trajectory includes an error applied to the reference trajectory and causes the extraterrestrial vehicle to end at a different target than the user-specified target;
separate a duration of the reference trajectory into a plurality of operational cycles, wherein each of the plurality of operational cycles represent time durations in which the extraterrestrial vehicle flies a particular trajectory before updating an onboard thrust profile based on an estimate of a state of the extraterrestrial vehicle;
obtain a thrust profile for an operational cycle of the plurality of operational cycles, wherein the thrust profile causes the extraterrestrial vehicle to reach a target position along the reference trajectory at a termination of the operational cycle;
apply the thrust profile to the truth trajectory for the operational cycle, wherein applying the thrust profile reduces at least some movement of the extraterrestrial vehicle due to the error.

2. The trajectory determination system of claim 1, wherein an initial position of the extraterrestrial vehicle for a subsequent operational cycle is an end position of the extraterrestrial vehicle for the operational cycle.

3. The trajectory determination system of claim 1, wherein the computer-executable instructions, when executed, further cause the processor to obtain simulated trajectory executions for the operational cycle, wherein obtaining the simulated trajectory executions is based on a plurality of simulated flights of the extraterrestrial vehicle according to variations of the error, wherein the simulated trajectory executions provide a probability of success for the extraterrestrial vehicle to reach the user-specified target.

4. The trajectory determination system of claim 3, wherein the simulated trajectory executions are Monte Carlo simulations of the extraterrestrial vehicle following the operational cycle.

5. The trajectory determination system of claim 4, wherein the simulated trajectory executions are simulated in parallel.

6. The trajectory determination system of claim 3, wherein the computer-executable instructions, when executed, further cause the processor to determine a probability of the extraterrestrial vehicle reaching the user-specified target based on following applications of the thrust profile to the truth trajectory.

7. The trajectory determination system of claim 6, wherein the computer-executable instructions, when executed, further cause the processor to, in response to the probability being greater than a trajectory probability, select an operations architecture with the probability greater than an accuracy threshold to reach the user-specified target.

8. The trajectory determination system of claim 1, wherein the computer-executable instructions, when executed, further cause the processor to:
generate instructions for the operational cycle to allow the extraterrestrial vehicle to reach the target position at the termination of the operational cycle; and
transmit the instructions to the extraterrestrial vehicle.

9. The trajectory determination system of claim 1, wherein the computer-executable instructions, when executed, further cause the processor to:
generate instructions for a subsequent operational cycle to allow the extraterrestrial vehicle to reach another target position at the termination of the subsequent operational cycle; and
transmit the instructions to the extraterrestrial vehicle.

10. The trajectory determination system of claim 1, wherein the operational cycle corresponds to a flight time duration of the extraterrestrial vehicle.

11. The trajectory determination system of claim 10, wherein the operational cycle is between 5 and 14 days of flight time.

12. A method comprising:
obtaining a reference trajectory for an extraterrestrial vehicle, wherein the reference trajectory begins at an initial state of the extraterrestrial vehicle and ends at a user-specified target;
obtaining a truth trajectory for the extraterrestrial vehicle that identifies estimated movement of the extraterrestrial vehicle from the initial state towards the user-specified target, wherein the truth trajectory includes an error applied to the reference trajectory and causes the extraterrestrial vehicle to end at a different target than the user-specified target;
separating a duration of the reference trajectory into a plurality of operational cycles, wherein each of the plurality of operational cycles represent time durations in which the extraterrestrial vehicle flies a particular trajectory before updating an onboard thrust profile based on an estimate of a state of the extraterrestrial vehicle;
obtaining a thrust profile for an operational cycle of the plurality of operational cycles, wherein the thrust profile causes the extraterrestrial vehicle to reach a target position along the reference trajectory at a termination of the operational cycle;
applying the thrust profile to the truth trajectory for the operational cycle, wherein applying of the thrust profile reduces at least some movement of the extraterrestrial vehicle due to the error.

13. The method of claim 12, wherein an initial position of the extraterrestrial vehicle for a subsequent operational cycle is an end position of the extraterrestrial vehicle for the operational cycle.

14. The method of claim 12, further comprising obtaining simulated trajectory executions for the operational cycle, wherein obtaining the simulated trajectory executions is based on a plurality of simulated flights of the extraterrestrial vehicle according to variations of the error, wherein the simulated trajectory executions provide a probability of success for the extraterrestrial vehicle to reach the user-specified target.

15. The method of claim 14, wherein the simulated trajectory executions are Monte Carlo simulations of the extraterrestrial vehicle following the operational cycle.

16. The method of claim 15, wherein the simulated trajectory executions are simulated in parallel.

17. The method of claim 14, further comprising determining a probability of the extraterrestrial vehicle reaching the user-specified target based on following applications of the thrust profile to the truth trajectory.

18. The method of claim 17, further comprising, in response to the probability being greater than a trajectory probability, selecting an operations architecture with the probability greater than an accuracy threshold to reach the user-specified target.

19. The method of claim 12, further comprising:
generating instructions for the operational cycle to allow the extraterrestrial vehicle to reach the target position at the termination of the operational cycle; and
transmitting the instructions to the extraterrestrial vehicle.

20. The method of claim 12, further comprising:
generating instructions for a subsequent operational cycle to allow the extraterrestrial vehicle to reach another target position at the termination of the subsequent operational cycle; and
transmitting the instructions to the extraterrestrial vehicle.
